(19) United States
(12) Patent Application Publication
(10) Pub. No.: US 2018/0285935 A1
(43) Pub. Date: Oct. 4, 2018

(54) MOBILE ADVERTISEMENT DEVICE, ADVERTISEMENT PLAYING SYSTEM AND METHOD

(71) Applicant: HONGFUJIN PRECISION ELECTRONICS (TIANJIN) CO.,LTD., Tianjin (CN)

(72) Inventors: CHUANG-WEI TSENG, New Taipei (TW); YU-CHING CHIEN, New Taipei (TW); KAI-FU CHEN, New Taipei (TW); CHIA-YUN LEE, New Taipei (TW)

(21) Appl. No.: 15/491,594

(22) Filed: Apr. 19, 2017

(30) Foreign Application Priority Data
Mar. 30, 2017 (CN) 201710201295.2

(51) Int. Cl. G06Q 30/02; H04L 29/08

(52) U.S. Cl. CPC G06Q 30/0269; G06K 9/78; G06Q 30/0267; H04L 67/10

(57) ABSTRACT

A mobile advertisement device for playing back advertisements and advertisement types according to the current crown-sourcing structure information includes a driving module, an image capturing module, a processing module, and a display module. The driving module drives the mobile advertisement device to move. The image capturing module captures a plurality of images. The processing module processes the images to obtain crown-sourcing structure information. The display module plays back certain advertisements or advertisements at certain frequencies according to the crown-sourcing structure information. An advertisement playback system and method are also provided.

### FIELD

The subject matter herein generally relates to advertising.

### BACKGROUND

Advertisement is the process through which companies attempt to persuade customers to purchase their products. Advertisement takes many forms including in-store audio advertisements, television advertisements, billboards, etc. These advertisement playing devices can play advertisements in a fixed location but cannot identify a target group for a particular product, which can then be used to maximize the efficiency of a particular advertisement directed at selling the product.

### BRIEF DESCRIPTION OF THE DRAWINGS

Implementations of the present technology will now be described, by way of example only, with reference to the attached figures.

FIG. 1 is a diagram of an exemplary embodiment of an advertisement playback system.

FIG. 2 is a block diagram of an exemplary embodiment of a mobile advertisement device.

FIG. 3 is a block diagram of an another exemplary embodiment of the mobile advertisement device.

FIG. 4 is a flow diagram of an exemplary embodiment of an advertisement playing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

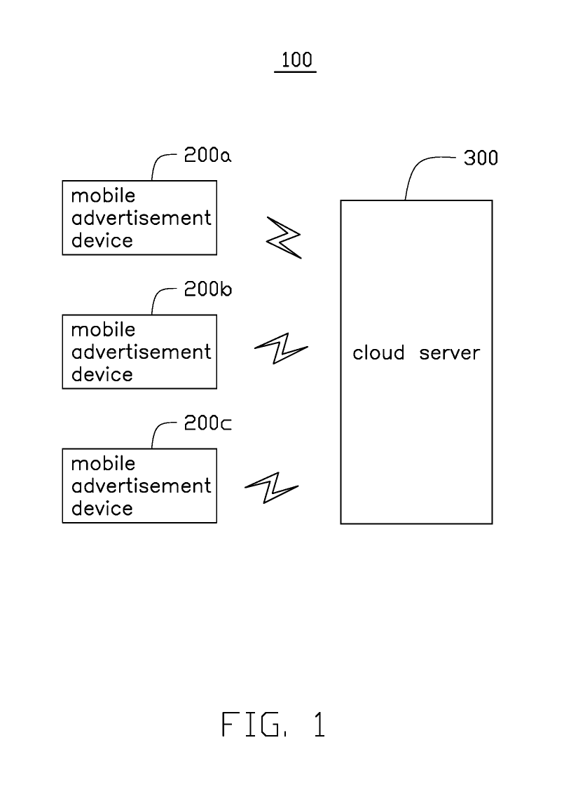

FIG. 1 illustrates an advertisement playback system 100 in accordance with an exemplary embodiment.

The advertisement playback system 100 comprises a plurality of mobile advertisement devices and a cloud server 300. The plurality of mobile advertisement devices in this exemplary embodiment comprises three mobile advertisement devices, 200a to 200c.

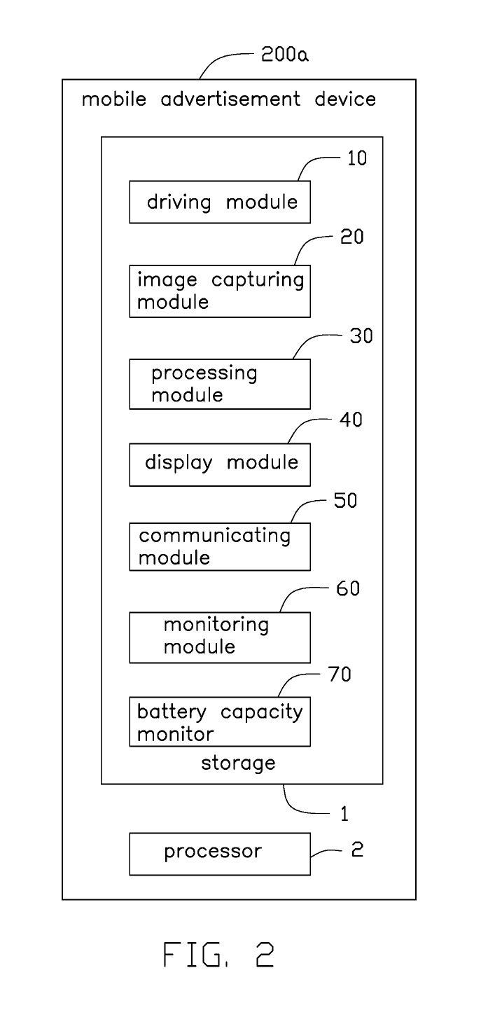

Referring to FIG. 2, each of the mobile advertisement devices 200a to 200c can comprise at least one storage 1 and at least one processor 2. Each of the mobile advertisement devices 200a to 200c can further comprises a plurality of modules, such as a driving module 10, an image capturing module 20, a processing module 30, and a display module 40. The modules 10-40 can comprise one or more software programs in the form of computerized codes stored in the storage 1. The computerized codes can include instructions that can be executed by the processor 2 to provide functions for the modules 10-40.

The driving module 10 is configured to drive the mobile advertisement device 200a to move. The image capturing module 20 is configured to capture a plurality of images. The processing module 30 is configured to process the images to obtain crown-sourcing structure information. The display module 40 is configured to play back advertisements according to the crown-sourcing structure information. The advertisements can be stored in the storage 1.

In one exemplary embodiment, the driving module 10 drives the mobile advertisement device 200a to move in a predetermined path. Each of the mobile advertisement devices 200a to 200c can comprise different predetermined paths, and each of the mobile advertisement devices 200a to 200c can have an autonomous obstacle avoidance system.

In one exemplary embodiment, the image capturing module 20 can capture the plurality of images of scene surrounding the mobile advertisement device 200a. A method for processing the images by the processing module 30 can comprise face recognition, gender recognition, age recognition, clothing recognition, and stature recognition.

Different groups may pay attention to different advertisements, and the display module 40 can play back different advertisements according to the crown-sourcing structure information. For example, the crown-sourcing structure information can indicate a businessmen group, an elderly group of people, a group of children, a large number of people being obese, a group of ladies, and a student group. The businessmen may pay attention to investing and financing advertisements, the elderly may pay attention to health advertisements, the children may pay attention to advertisements for toys and candies, the group of people being obese may pay attention to weight-loss advertisements, the ladies may pay attention to cosmetics or clothing advertisements, and the student group may pay attention to educational advertisements.

In one exemplary embodiment, the processing module 30 is further configured to count the number of people in each group or nominal group, and the display module 40 is further configured to play back advertisements according to the crown-sourcing structure information and the number of people of each group. For example, the crown-sourcing structure information can comprise of three groups (businessmen group, elderly group, and ladies group). In the exemplary embodiment, the number of businessmen is the most, and the number of elderly people is the least. Then, frequency of the investing and financing advertisements played by the display module 40 will be the most, and frequency of health advertisements played by the display module 40 will be the least. The display module 40 can regulate a playback frequency of each type advertisement according to the number of people of each group.

In one exemplary embodiment, the display module 40 can be a liquid crystal display (LCD) screen or a projector.

In one exemplary embodiment, the mobile advertisement device 200a further comprises a communicating module 50. The communicating module 50 is configured to communicate with the cloud server 300 and receive advertisements from the cloud server 30. The communicating module 50 is further configured to transmit images to the cloud server 300, and the cloud server 300 can process the images based on big data analytics.

In one exemplary embodiment, the mobile advertisement device 200a further comprises a monitoring module 60. The monitoring module 60 is configured to provide video monitoring service and fire monitoring service.

Configurations and features of the mobile advertisement devices 200b, 200c, and 200d are substantially the same as for those of the mobile advertisement device 200a.

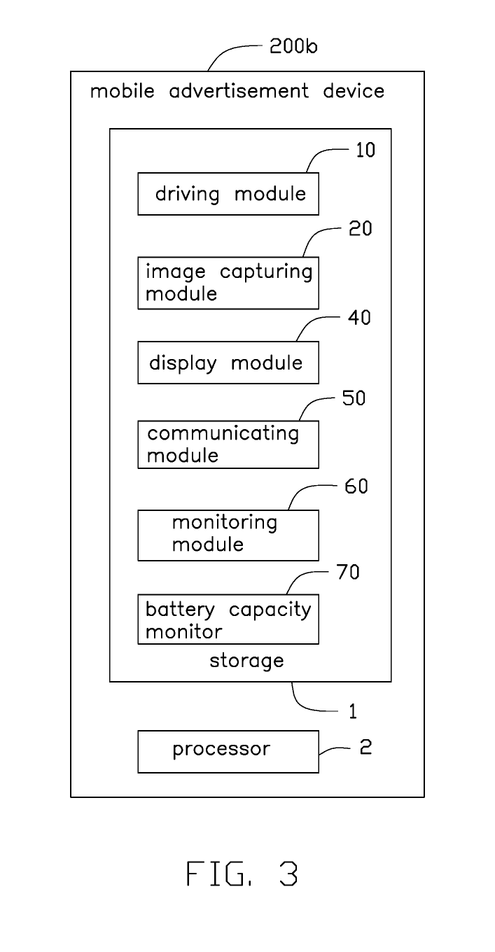

Referring to FIG. 3, the processing module 30 can be omitted, and the cloud server 300 can be configured to process the images and obtain the crown-sourcing structure information. The mobile advertisement device 200b transmits the images captured by the image capturing module 20 to the cloud server 300 through the communicating module 50. The cloud server 300 processes the images to obtain the crown-sourcing structure information and outputs advertisements to the display module 40 for playback.

In one exemplary embodiment, the cloud server 300 further counts the number of people of each group and outputs advertisements to the display module 40 according to the crown-sourcing structure information and the number of people of each group.

In one exemplary embodiment, each of the mobile advertisement device 200a to 200c further comprises a battery capacity monitor 70. When the battery capacity monitoring module 70 detects a battery level of each mobile advertisement device as less than a predetermined value, the mobile advertisement devices 200a to 200c take shifts in recharging according to a predetermined recharging order. Then, the mobile advertisement devices 200a to 200c can work 24 hours a day.

For example, the predetermined value is set as twenty percent. The mobile advertisement devices 200a to 200c can search power sources to recharge through a position system.

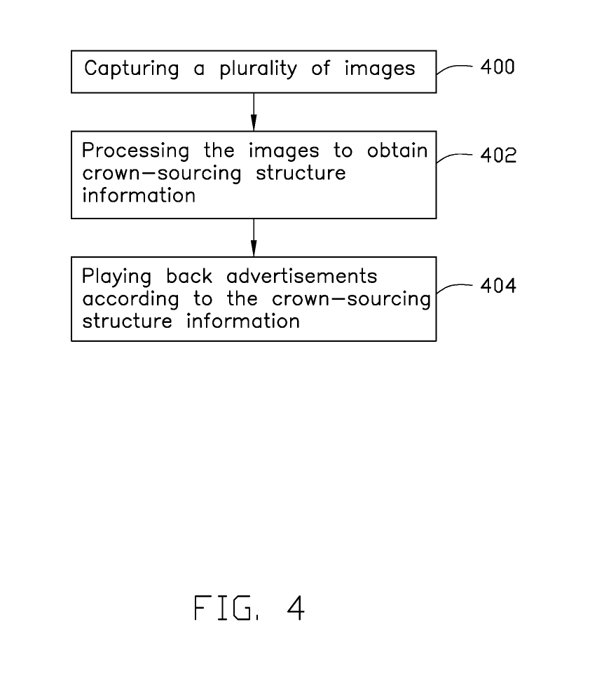

FIG. 4 illustrates one exemplary embodiment of an advertisement playing method. The flowchart presents an exemplary embodiment of the method. The exemplary method is provided by way of example, as there are a variety of ways to carry out the method. The method described below can be carried out using the configurations illustrated in FIG. 2, for example, and various elements of these figures are referenced in explaining the example method. Each step shown in FIG. 4 represents one or more processes, methods, or subroutines, carried out in the example method. Furthermore, the illustrated order of steps is illustrative only and the order of the steps can change. Additional steps can be added or fewer steps may be utilized, without departing from this disclosure. The example method can begin at step 400.

In step 400, the image capturing module 20 captures a plurality of images.

In step 402, the processing module 30 processes the images to obtain crown-sourcing structure information.

In step 404, the display module 40 plays back advertisements according to the crown-sourcing structure information.

In one exemplary embodiment, the image capturing module 20 can capture the plurality of images of scene surrounding the mobile advertisement device 200a. A method for processing the images by the processing module 30 can comprise face recognition, gender recognition, age recognition, clothing recognition, and stature recognition.

In one exemplary embodiment, the processing module 30 counts the number of people of each group, and the display module 40 further plays back advertisements according to the crown-sourcing structure information and the number of people of each group.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An advertisement playing method comprising:
capturing a plurality of images;
processing the images to obtain crown-sourcing structure information; and
playing back advertisements according to the crown-sourcing structure information.

2. The advertisement playing method of claim 1, wherein the method for processing the images comprises face recognition, gender recognition, age recognition, clothing recognition, and stature recognition.

3. The advertisement playing method of claim 1, wherein when the crown-sourcing structure information comprises of two or more people groups, the step of playing advertisements according to the crown-sourcing structure information comprises:
counting the number of people of each group; and
playing back advertisements according to the crown-sourcing structure information and the number of people of each group.

4. A mobile advertisement device comprising:
at least one storage configured to store a plurality of modules, the plurality of modules being a collection of instructions of an application operable in the device;
at least one processor configured to execute the plurality of modules, the modules comprising:
a driving module driving the mobile advertisement device to move;
a image capturing module capturing a plurality of images;
a processing module processing the images to obtain crown-sourcing structure information; and
a display module playing back advertisements according to the crown-sourcing structure information.

5. The mobile advertisement device of claim 4, wherein the method for processing the images by the processing module comprises face recognition, gender recognition, age recognition, clothing recognition, and stature recognition.

6. The mobile advertisement device of claim 4, wherein when the crown-sourcing structure information comprises of two or more people groups, the processing module further counts the number of people of each group, and the display module further plays back advertisements according to the crown-sourcing structure information and the number of people of each group.

7. The mobile advertisement device of claim 4, further comprising a communicating module communicating with a cloud server and receiving the advertisements from the cloud server, and the communicating module transmitting the images to the cloud server.

8. The mobile advertisement device of claim 7, wherein the storage stores the advertisements.

9. The mobile advertisement device of claim 4, further comprising a monitoring module providing video monitoring and fire monitoring.

10. An advertisement playing system comprising:
a cloud server; and
a plurality of mobile advertisement devices, each mobile advertisement device comprising:
a driving module driving the mobile advertisement device to move;
a image capturing module capturing a plurality of images;
a communicating module transmitting the images to the cloud server; and
a display module;
wherein the cloud server processes the images to obtain crown-sourcing structure information, the cloud server further outputs advertisements to the display module to play back according to the crown-sourcing structure information.

11. The advertisement playing system of claim 10, wherein when the crown-sourcing structure information comprises of two or more people groups, the cloud server further counts the number of people of each group and output advertisements to the display module according to the crown-sourcing structure information and the number of people of each group.

12. The advertisement playing system of claim 10, wherein the method for processing the images by the cloud server comprises face recognition, gender recognition, age recognition, clothing recognition, and stature recognition.

13. The advertisement playing system of claim 10, wherein each mobile advertisement device further comprises a storage to store the advertisements.

14. The advertisement playing system of claim 10, wherein each mobile advertisement device further comprises a monitoring module to provide video monitoring and fire monitoring.

15. The advertisement playing system of claim 10, wherein each mobile advertisement device further comprises a battery capacity monitor; when the battery capacity monitoring module detects a battery level is less than a predetermined value, the mobile advertisement devices take shifts in recharging according to a predetermined recharging order.
